(19) United States
(12) Patent Application Publication
(10) Pub. No.: US 2018/0184636 A1
(43) Pub. Date: Jul. 5, 2018

(54) Bug Catcher

(71) Applicant: Maki Yamamoto, Honolulu, HI (US)

(72) Inventor: Maki Yamamoto, Honolulu, HI (US)

(21) Appl. No.: 15/394,812

(22) Filed: Dec. 30, 2016

(51) Int. Cl. A01M 3/00; A01M 1/10

(52) U.S. Cl. CPC A01M 3/00; A01M 1/103

(57) ABSTRACT

A device for trapping insects. The device for trapping insects of the disclosure includes a housing with a receiver and a lid portion for trapping the insects, bugs and roaches. The receiver includes a groove portion configured to receive the lid to close the housing.

### FIELD OF THE DISCLOSURE

The present disclosure relates to a device for catching and trapping insects resting or walking on a surface.

### BACKGROUND OF THE DISCLOSURE

Many different types of insect trap device currently are available. However, most of such devices are designed to kill the insects, and are not able to capture and release it safely.

Muehlinghaus; Heinrich, U.S. Pat. No. 5,522,173 A, sets forth a device for trapping, observing and transporting insects, spiders and other small animals, comprising a catching apparatus open an one side and closable with the aid of a flexible slide plate and a grip mechanism connected thereto, in which the flexible slide plate is guided in a twice reversed (curved) path supporting its top and bottom to the catching opening of the catching apparatus and is displaceable by an operating button.

Flaherty Michael C, U.S. Patent Application No. 20090044443 A1, sets forth an apparatus to enable users to pick up and dispose of bugs, insects, small animals, and other small creatures. The apparatus comprises a bubble member having an open bottom and each of a predetermined shape and a predetermined size and formed of a first predetermined material. A handle member is attached to an outer surface of the aid bubble member at a predetermined location for maneuvering such bubble member. A bottom tray member is sliding engage able with a bottom portion of the bubble member for closing the open bottom of the bubble member, such bottom tray member is formed of a second predetermined material.

Young Todd M, U.S. Patent Application No. 20080040967 A1, sets forth a bug trap device configured to trap and eliminate bugs or insects, particularly in the household or workplace. The bug trap device includes a handle portion connected to a trap portion. The handle allows a user to grip one end of the handle and remotely manipulate the trap portion connected to an opposite end of the handle.

It is apparent now that numerous innovations in device for trapping insects have been provided in the prior art that is adequate for various purposes. Furthermore, even though these innovations may be suitable for the specific individual purposes to which they address, accordingly, they would not be suitable for the purposes of the present disclosure as heretofore described.

### SUMMARY OF THE DISCLOSURE

The present disclosure has been developed in response to the present state of the art, and in particular, in response to the problems and needs in the art that have not yet been fully solved by the currently available device for trapping insects. Accordingly, the present disclosure has been developed to provide an apparatus for trapping device for insects with housing for trapping and releasing the insects and also allowing quick and easy trapping of the insects and other bugs.

It is therefore a primary object of the present disclosure to provide an improved handheld device for trapping insects.

It is another object of the present disclosure to provide a device for trapping insects, including housing with long handle, and a bottom slider.

In an example embodiment, the device includes a top container portion that is configured to cup the insects and bottom sliding portion that is configured to trap the insect when a lid is slide inward. By pulling the lid outward, a user is, able to release the trapped insect.

An even further object of the present disclosure is to provide the device for trapping insects on the flat surface, such as floors and walls.

Still yet another object of the present disclosure is to provide a device for trapping insects and is made from a clear transparent material.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attained by its uses, reference should be had to the accompanying drawings and descriptive matter in which there are illustrated preferred embodiments of the disclosure.

### BRIEF DESCRIPTION OF THE DRAWINGS

The example embodiments of the inventive aspects will be better understood from the following brief description taken in conjunction with the accompanying drawings. The drawing FIGS. 1-6 represent non-limiting, example embodiments.

FIG. 1 is a perspective view of a housing of trapping device for insects in accordance with an embodiment of the present disclosure.

FIG. 2 is another perspective view of a housing of the trapping device for insects in accordance with an embodiment of the present disclosure.

FIG. 3 is a perspective full view of the device for trapping insects in accordance with an embodiment of the present disclosure.

FIG. 4 is a bottom view showing a portion of the housing to receive a sliding sheet, in accordance with an example embodiment of the present disclosure.

FIG. 5 is a front view of a sliding sheet of trapping device for insects in accordance with an embodiment of the present disclosure.

FIG. 5 is a front view of a sliding sheet of trapping device for insects in accordance with an embodiment of the present disclosure.

FIG. 6 is a perspective view of a sliding sheet of trapping device for insects in accordance with another embodiment of the present disclosure.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that the embodiments may be combined, or that other embodiments may be utilized and that structural and logistical changes may be made without departing from the spirit and scope of the present disclosure.

These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

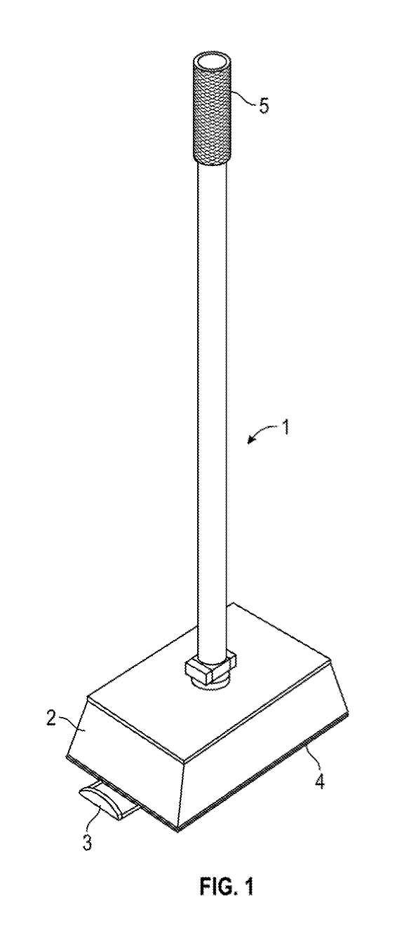

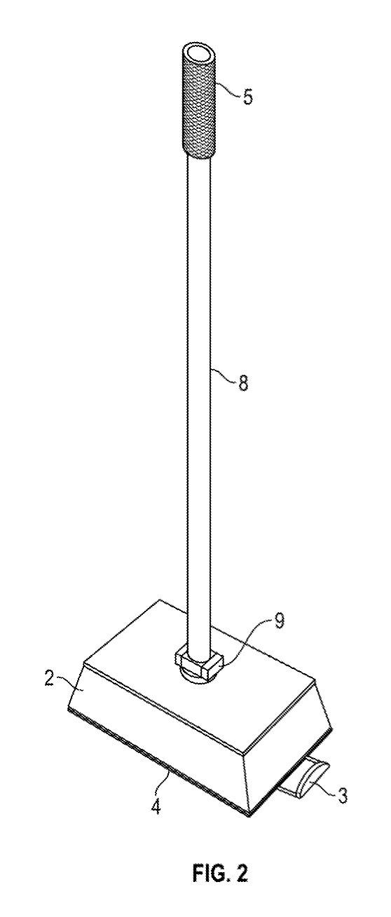

As shown in FIGS. 1-5, the insect trapping device 1 includes a housing 2 and a sliding bottom sheet 5 connected together. The housing 2 and a bottom sheet 5 can be made as separate units and then assembled together by sliding the bottom 5 into the slider 4 as shown in FIG. 2. The sliding sheet 5 functions as a lid to close the housing when it is pulled inward.

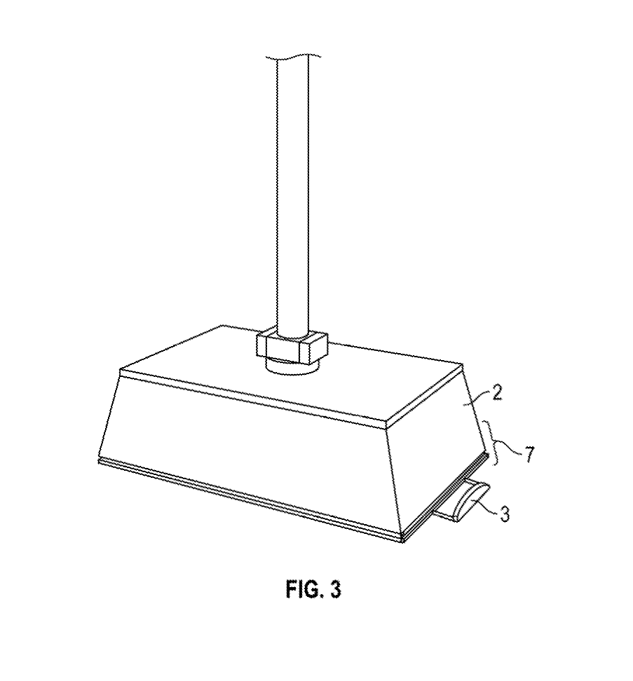

FIG. 3 shows a full view of the trapping device 1. The trapping device include a long handle 8. The size of the handle depends upon size of the trapping device.

FIG. 2-5 show the housing 2 comprising a handle portion 8, the slider portion 7, bottom sheet portion 5 with a handle 3. By pulling handle 3, a user is able to open the bottom and release the insect.

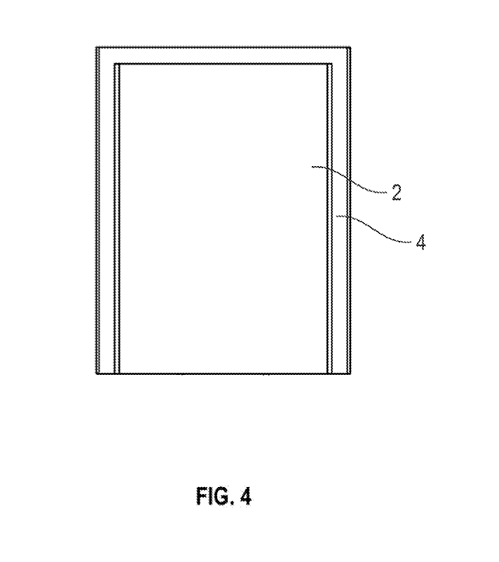

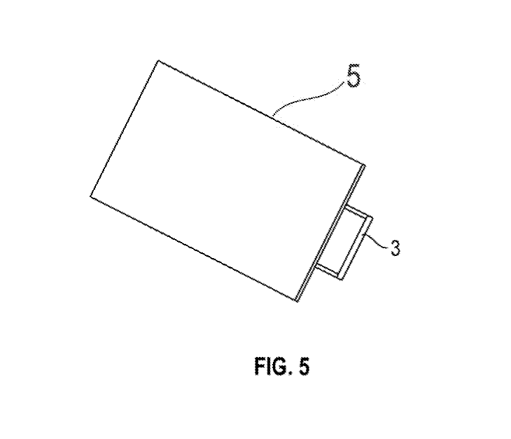

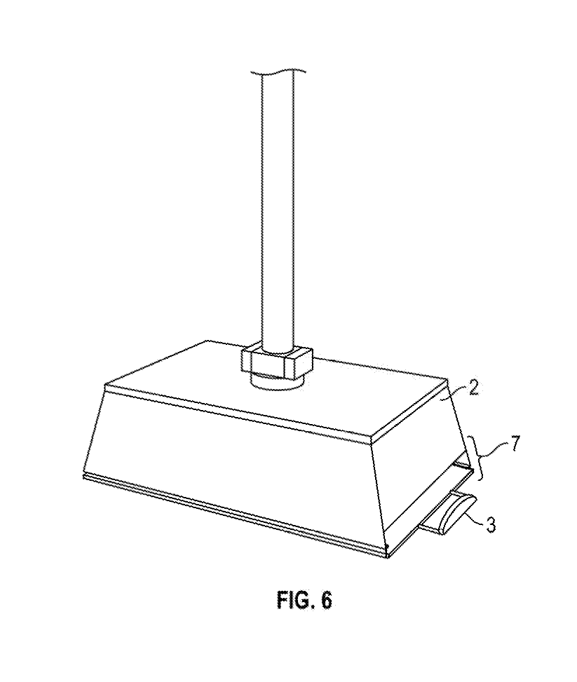

FIG. 4 shows the bottom of the housing. Bottom of housing includes a groove portion on its three sides and is configured to receive and hold the sliding bottom piece 5 flash to the ground. FIG. 5 shows a separate bottom sheet 5 with a handle 3. The sheet 5 is configured to slide into the slider 4.

In an implementation, the bottom sheet 5 is pulled out and as an insect crawls into the sheet 5, the sheet is pushed into the housing 2 so that the inset is trapped.

In another embodiment, the sheet 5 and housing 2 may be configured such that the sheet is hingedly attached to the housing 2. When an insect crawls into the sheet 5, the housing 2 may be rotated to cup the insect via the hinge to snap fit with the sheet 5.

In another example embodiment, the housing includes an opening region 7 for allowing insects get into the trap as the bottom sheet 5 is pushed inside the trap. In yet another example embodiment, the wall above the opening region 7 is configured to slide up or down via grooves on the sides.

The insect trap device may be made of a clear, lightweight and a transparent material such as plastic or glass. One important feature to consider when selecting an appropriate material is that the embodiment of this disclosure is capable of trapping and releasing the insects into itself to form a housing that can allow the user to conveniently carry from one place to another.

It is to be understood that the above description is intended'to be illustrative, and not restrictive. For example, the above-discussed embodiments may be used in combination with each other. Many other embodiments will be apparent to those of skill in the art upon reviewing the above description.

The benefits and advantages which may be provided by the present disclosure have been described above with regard to specific embodiments. These benefits and advantages, and any elements or limitations that may cause them to occur or to become more pronounced are not to he construed as critical, required, or essential features of any or all of the embodiments.

While the present disclosure has been described with reference to particular embodiments, it should be understood that the embodiments are illustrative and that the scope of the disclosure is not limited to these embodiments. Many variations, modifications, additions and improvements to the embodiments described above are possible. It is contemplated that these variations, modifications, additions and improvements fall within the scope of the disclosure.

What is claimed is:

1. A device for trapping insects, comprising:
a housing having a top portion, four side portions, and a slider region at the bottom of the housing;
a lid having a tab for holding the lid, wherein,
the lid is configured to slide into the slider to close the housing.

2. The device as claimed in claim 1, wherein a receiver of said housing is configured to trap the insects by forming closed housing and herein the insect is captured by sliding the lid into the slider.

3. A transparent device for trapping insects, the device comprising:
a housing having a top portion, four side portions, and a slider region at the bottom of the housing;
a handle attached to the top portion and configured to rotate in a cone angle; and
a lid having a tab for holding the lid, wherein,
the lid is configured to slide into the slider to close the housing.

4. The device as claimed in claim 3, wherein the slider region is a groove region in and around the bottom of the housing.

5. The device as claimed in claim 3, wherein the lid is removably attached to the housing.

6. The device as claimed in claim 3, wherein one of the four side portions is a front portion and is configured to slide.

7. The device as claimed in claim 6, wherein the housing includes a groove on the two sides and the front portion is configured to slide in the groove and stay in place.
